(19) United States
(12) Patent Application Publication
(10) Pub. No.: US 2007/0299972 A1
(43) Pub. Date: Dec. 27, 2007

(54) RELAY OF ENTERPRISE MESSAGING SYSTEM EVENTS AMONG CLIENT DEVICES AND ONE OR MORE ENTERPRISE MESSAGING SYSTEMS

(75) Inventors: Nevon Brake, St. John's (CA); Matthew Troke, St. John's (CA)

Correspondence Address: BEYER WEAVER LLP, P.O. BOX 70250, OAKLAND, CA, 94612-0250, US

(73) Assignee: Consilient Technologies Corporation, St. John's (CA)

(21) Appl. No.: 11/381,084

(22) Filed: May 1, 2006

Related U.S. Application Data
(60) Provisional application No. 60/708,076, filed on Aug. 12, 2005.
(60) Provisional application No. 60/722,927, filed on Sep. 29, 2005.
(60) Provisional application No. 60/597,959, filed on Dec. 28, 2005.
(60) Provisional application No. 60/781,215, filed on Mar. 10, 2006.

(51) Int. Cl. G06F 15/16; G06F 15/173

(52) U.S. Cl. 709/226; 709/206

(57) ABSTRACT

A system is configured to interface a plurality of electronic messaging systems to a plurality of client devices connectable wirelessly to the system. At least some of the electronic messaging systems process messaging system events according to a first particular messaging system format that is different from a second particular messaging system format according to which others of the electronic messaging systems process messaging system events. The system includes a messaging system adaptor configured to receive the messaging system events having the first and second particular messaging system formats and to process the messaging system events at least to convert the messaging system events from the first and second particular messaging system formats into corresponding messaging system events having a normalized format. An enterprise relay service is configured to operate on the normalized-format messaging system events for interoperation of the client devices and the plurality of enterprise messaging systems.

### CROSS REFERENCE TO RELATED APPLICATIONS

This application claims the benefit of priority under 35 USC §119(e) to U.S. Provisional Patent Application No.: 60/708,076, entitled SYNCHRONIZATION OF ENTERPRISE MESSAGING SYSTEM EVENTS TO CLIENT DEVICES, filed on Aug. 12, 2005; U.S. Provisional Patent Application No.: 60/722,927, entitled SYNCHRONIZATION OF ENTERPRISE MESSAGING SYSTEM EVENTS TO CLIENT DEVICES, filed on Sep. 29, 2005; U.S. Provisional Patent Application No.: 60/597,959, entitled SYNCHRONIZATION OF ENTERPRISE MESSAGING SYSTEM EVENTS TO CLIENT DEVICES, filed on Dec. 28, 2005; and U.S. Provisional Patent Application No.: 60/781,215, entitled SYNCHRONIZATION OF ENTERPRISE MESSAGING SYSTEM EVENTS TO CLIENT DEVICES, filed on Mar. 10, 2006, all of which are incorporated herein by reference in their entirety.

### TECHNICAL FIELD

The present invention is in the field of electronic messaging and, in particular, relates to interfacing enterprise-based electronic messaging systems to client devices, such as wireless client devices.

### BACKGROUND

Providing users of wireless client devices access to enterprise messaging information such as e-mail, contacts and calendaring information (operated by an enterprise messaging server, such as Microsoft Exchange) is known. In particular, conventionally, one or more servers (more generally, a “service”) are provided (typically behind the enterprise firewall) to interact with the enterprise messaging server. More specifically, the service (typically known as an “enterprise server”) interacts with the enterprise messaging server to observe messaging system events and to synchronize those messaging system events (e.g., activities with respect to e-mail, such as receipt of a new e-mail or deletion of an e-mail; activities with respect to contacts, such as adding or deleting a contact, or modifying a contact; and activities with respect to calendar entries, such as adding or deleting a calendar entry, or modifying a calendar entry) between client devices (e.g., wireless client devices) or to the enterprise messaging server, as appropriate.

In a conventional architecture, wireless carriers set up a virtual private network connection between a network operations center (NOC), with which the enterprise server communicates, and wireless mobile client devices. The NOC synchronizes messaging events between the enterprise server and the mobile clients, or holds messaging events destined for the mobile client devices when the mobile client devices are out of coverage area, to be sent when the mobile client devices are again connected.

### SUMMARY

A system is configured to interface a plurality of electronic messaging systems to a plurality of client devices connectable wirelessly to the system. At least some of the electronic messaging systems process messaging system events according to a first particular messaging system format that is different from a second particular messaging system format according to which others of the electronic messaging systems process messaging system events.

The system includes a messaging system adaptor configured to receive the messaging system events having the first and second particular messaging system formats and to process the messaging system events at least to convert the messaging system events from the first and second particular messaging system formats into corresponding messaging system events having a normalized format. A relay engine is configured to relay the normalized-format messaging system events with client device messaging events communicated wirelessly between the client devices and the system.

### BRIEF DESCRIPTION OF FIGURES

FIG. 1 illustrates a basic architecture to couple messaging clients to a messaging system, including an enterprise server (more generically, termed a “relay engine”), and such that the architecture does not include a NOC.

FIG. 2 illustrates a basic architecture similar to the FIG. 1 architecture, where the relay engine operates as a NOC.

FIG. 3 illustrates more details of the relay engine, including how the relay engine is configured to process messaging system events in various formats from multiple to sources to multiple devices.

FIG. 3-1 illustrates relaying data from multiple sources to multiple devices while processing the data in various formats.

FIG. 4 is a flowchart illustrating a method for efficient garbage collection.

FIG. 5 illustrates a method to optimize relay of e-mail messaging events.

FIG. 5-1 shows processing for several sequential occurrences of heuristics processing of FIG. 5.

FIG. 6 illustrates an architecture particularly configured to perform protocol conversion with respect to particular messaging formats.

FIG. 7 illustrates an architecture configured to generate message signatures usable for performing conflict resolution during synchronization.

FIGS. 8-1 to 8-5 illustrate an architecture in which calendar entries and associated recurrence activities are processed in a normalized form.

### DETAILED DESCRIPTION

The operation of a conventional network operations center (NOC) is typically not configurable or otherwise controllable by the enterprises that subscribe to them. Rather, the NOC is typically operated and controlled by parties other than the enterprises themselves. As a result, for example, the NOC operator can set the price for its use. Furthermore, an enterprise synchronization server typically cannot handle electronic messages (for example, e-mails, calendar entries and contacts) in more than one format at a time. That is, the enterprise synchronization server is typically configured to handle messages in one format or another format, but not more than one.

It is desirable in some instances to operate a wireless messaging system without a NOC. Furthermore, there are some enterprises (typically, but not always, large enterprises, with many electronic messaging users) that have electronic messaging systems that operate in multiple formats. It would be desirable to provide a relay infrastructure to support such multiple messaging formats.

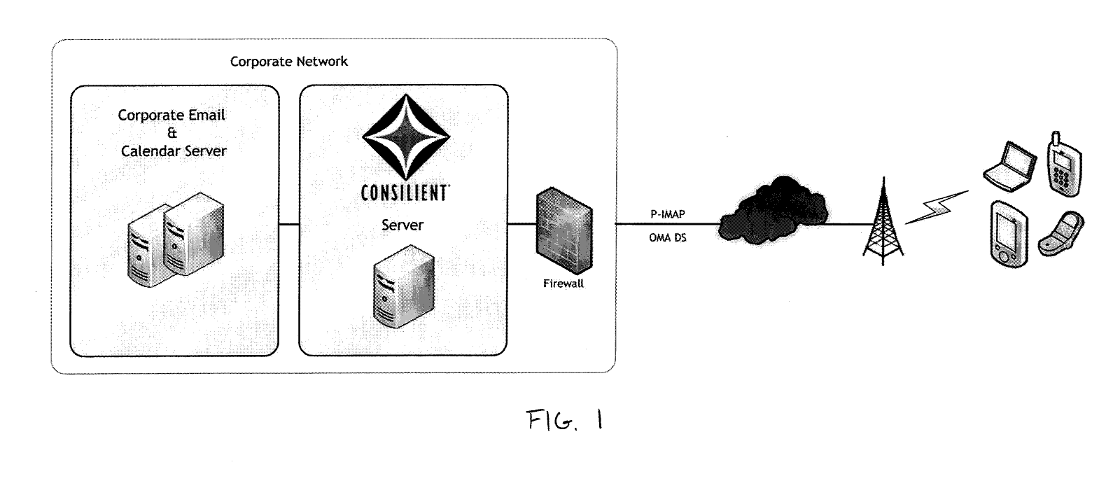

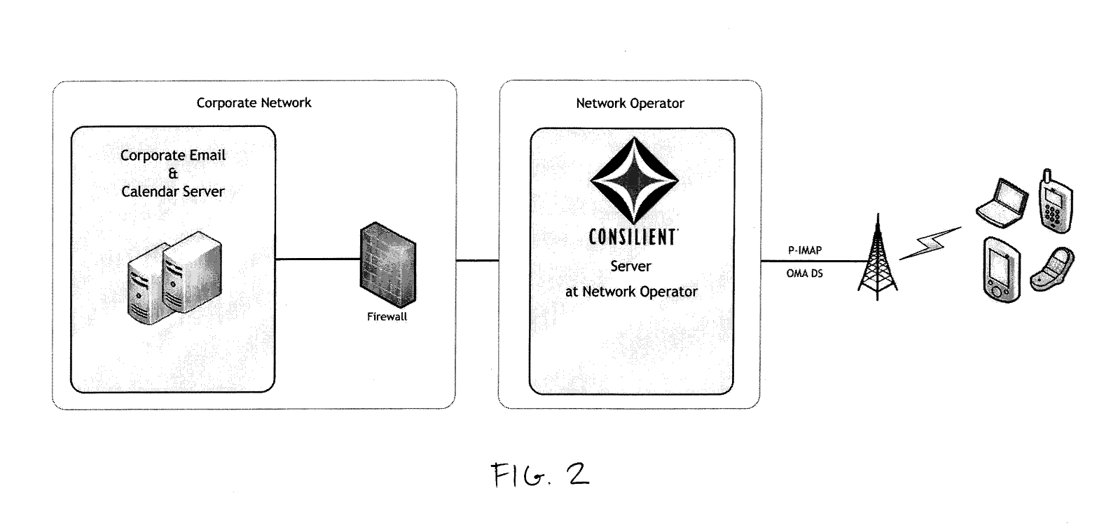

FIG. 1 illustrates an example “NOC-less” architecture, where an enterprise relay engine is provided behind the enterprise firewall, and communication with mobile client devices is not through a NOC. Thus, for example, communication between the enterprise relay engine and the mobile client devices may be via a generic data link, such as a TCP/IP link made available by many wireless carriers.

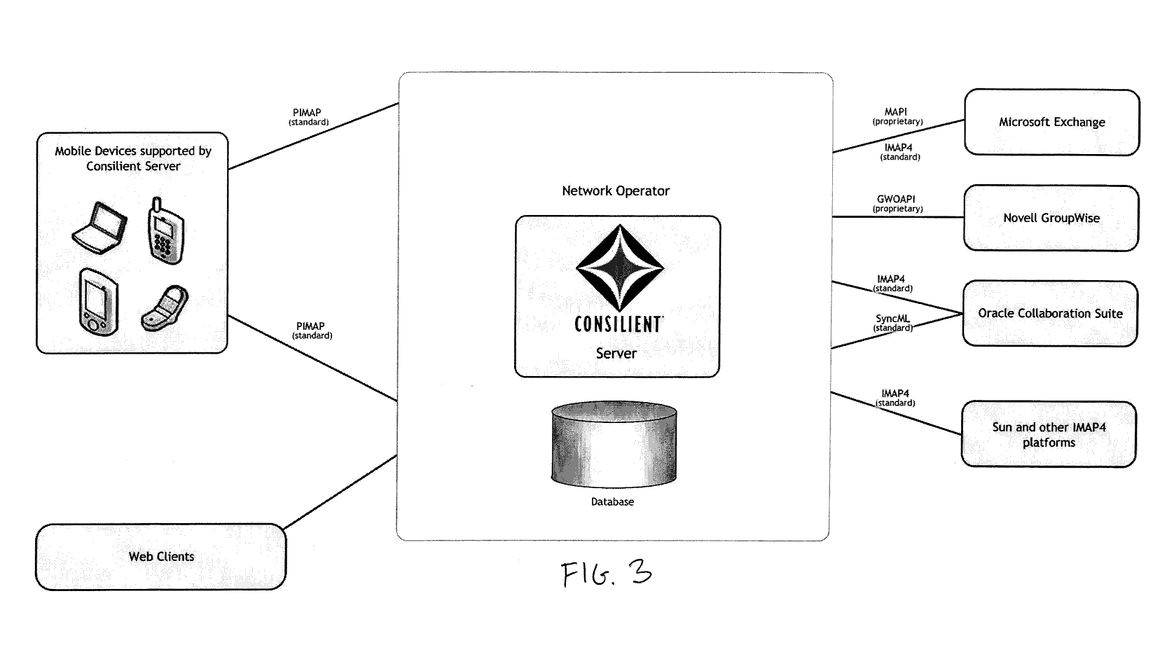

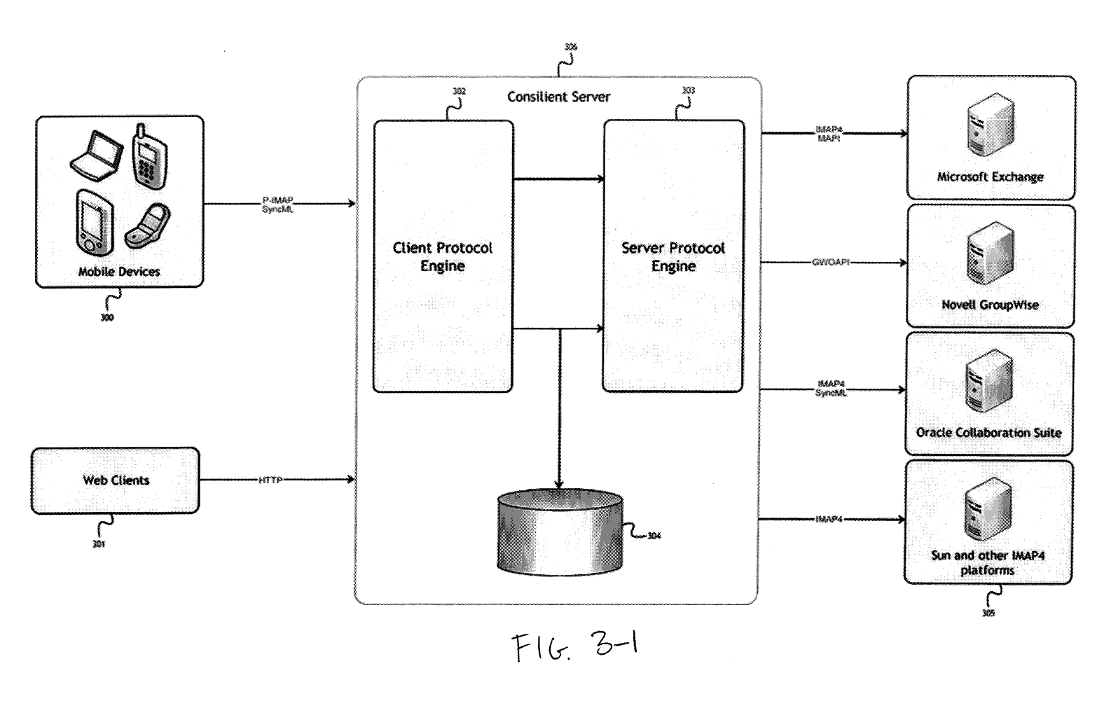

FIG. 2 illustrates an example architecture where functionality of an enterprise relay engine, like the relay engine in FIG. 1, is provided outside the enterprise firewall. The enterprise relay engine of the FIG. 2 configuration performs messaging system relay functions, and also performs functions that would typically be handled by a NOC, such forwarding (with or without storing) of events.

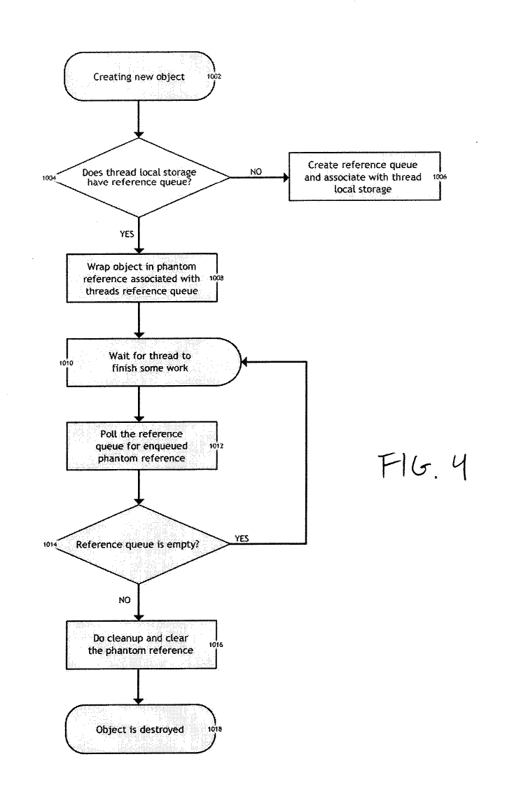

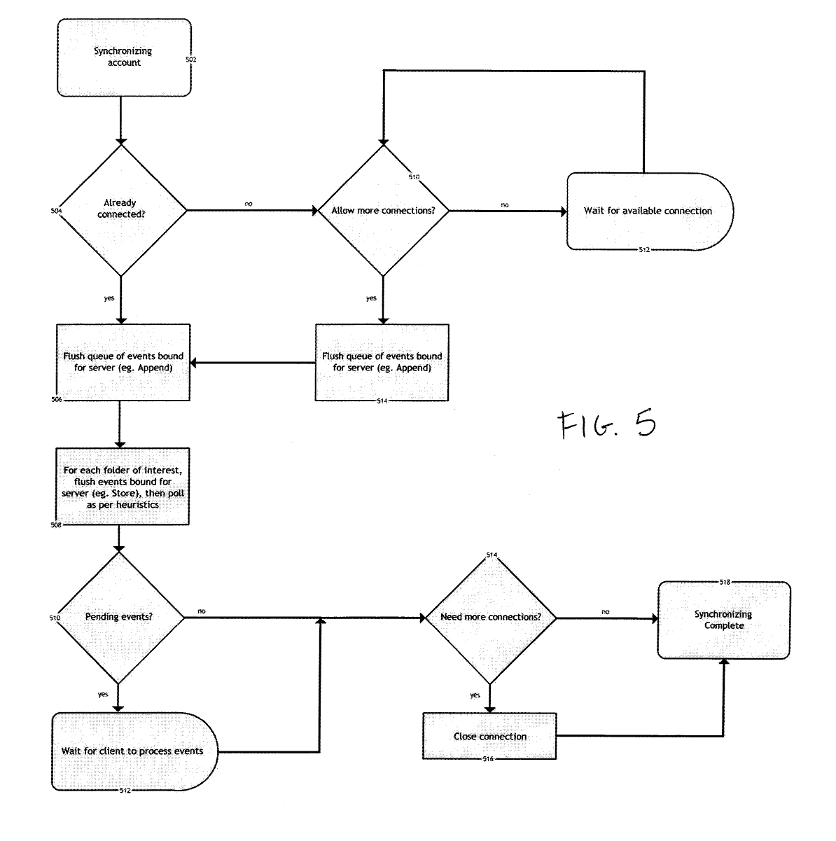

FIG. 3 illustrates an example architecture 300 of an enterprise relay engine that is configured or configurable to interface mobile users and, in some examples, non-mobile users, (collectively, 303) to enterprise messaging systems (collectively, 301) that operate in any of a plurality of formats. The FIG. 3 architecture 300 is usable, for example, in a NOC-less architecture (FIG. 1) or a NOC architecture (FIG. 2).

For example, the specific example of an enterprise relay service 302 shown in FIG. 3 interfaces to the enterprise messaging systems 301 operating in formats including MAPI (Messaging Application Programming Interface), which is a proprietary messaging format by Microsoft; IMAP4revl; GWOAPI (GroupWise Object Application Programming Interface), which is a proprietary messaging format from Novell; and SyncML. Messaging system events according to the messaging formats, destined for the enterprise relay service 302, are provided through an adaptor 304 (which may, in some examples, be allocated into a plurality of adaptors, for example, an adaptor for each messaging format). The adaptor 304 processes the messaging system events having specific messaging event formats and provides normalized messaging events 306.

The normalized messaging events 306 are provided to a relay engine 308 (which may be, for example, a synchronization engine) of the enterprise relay service 302. The relay engine 308 includes functionality for relaying (e.g., including synchronizing) messaging events between the enterprise messaging systems 301 and the e-mail clients 303. In one example, the normalized messaging events 306 are provided to the relay engine 308 using a standard JavaMail interface 307.

In general, the relay engine 308 relays the messaging system events among the enterprise messaging systems 301 and the e-mail clients 303. As part of the relay operation, the relay engine 308 provides messaging system events out to the e-mail clients 303. In one example, similar to the adaptor 304, the normalized messaging system events are provided to the e-mail clients 303 via an adaptor 312. The adaptor 312 converts the messaging system events having the normalized format, in which the relay engine 308 operates, into messaging events having messaging formats of the e-mail clients 303. For example, the messaging system events may be used by the e-mail clients 303 may include, as shown in FIG. 3, PIMAP, SyncML and HTTP delivery protocols.

As will be discussed later, in some examples, information to determine whether to perform a synchronization may be within the enterprise relay server 302, while in other examples, the information to actually perform the synchronization (which may depend on the particular synchronization, but typically where a “payload,” such as the body of an e-mail, may be needed to perform the synchronization) is retrieved from the enterprise messaging system 301 or from the client device 303.

FIG. 3-1 illustrates a synchronization technique from multiple enterprise messaging systems to multiple devices, where the relay engine 308 does not operate as a synchronization engine. Specifically, a plurality of mobile device clients 350 establish a connection to a Client Protocol Engine 352, of which there may be a plurality, within a messaging service 356 to accomplish actions corresponding to messaging events on the enterprise messaging services 355. The Client Protocol Engine 352 initiates a discovery protocol to determine a Server Protocol Engine 353, of which there may exist a plurality, to which it can connect.

The Server Protocol Engines 353interface to multiple enterprise messaging services 355, which may be operating according to various formats such as, for example, MAPI (Messaging Application Programming Interface), which is a proprietary messaging format by Microsoft; IMAP4revl; GWOAPI (GroupWise Object Application Programming Interface), which is a proprietary messaging format from Novell; and SyncML. The Server Protocol Engines 353 operate to transform the original messaging events from the mobile device clients 350 into a specific format appropriate for the particular enterprise messaging system 355 and transforming responses thereto from the enterprise messaging system 355 to a format to be returned to the client protocol engine 352 and subsequently to the originating mobile device clients 350.

Both the Client Protocol Engine 352 and Server Protocol Engine 353 may utilize a data store 354 to persist static data (e.g., configuration data for the Client Protocol Engine 352 or for the Server Protocol Engine 353) but, in one example, neither the Client Protocol Engine 352 nor the Server Protocol Engine 353 store messaging event data or responses in the data store354.

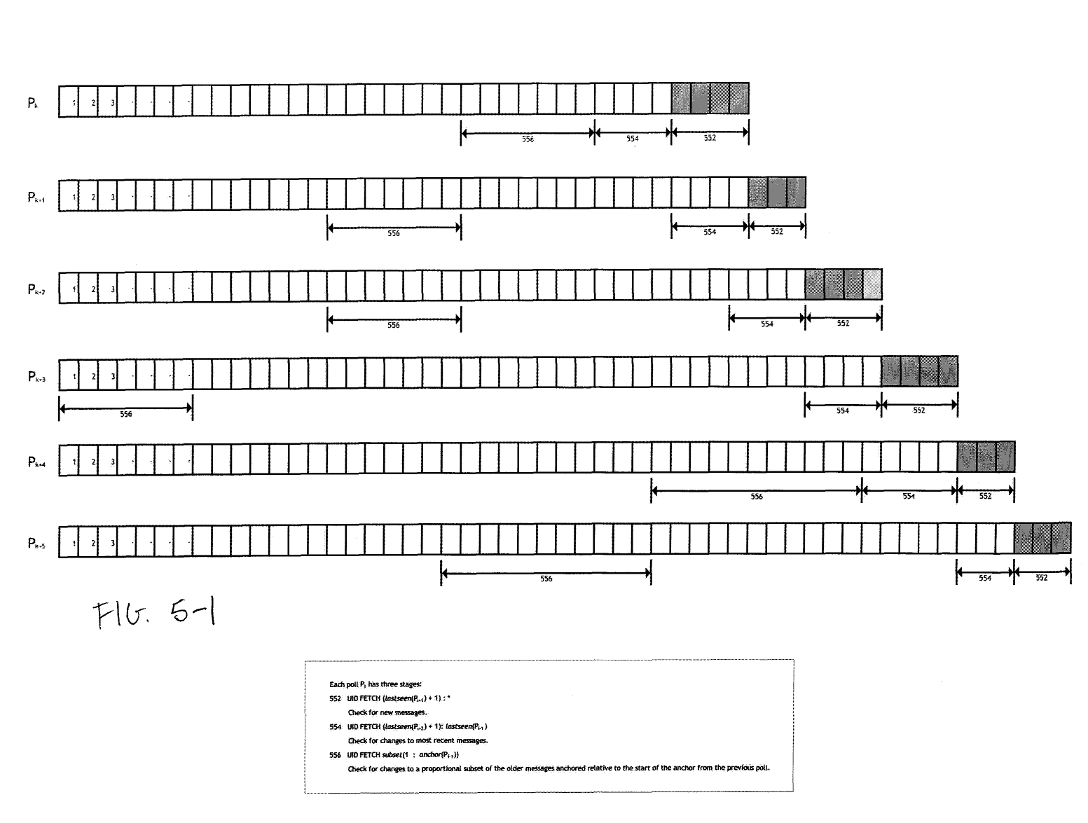

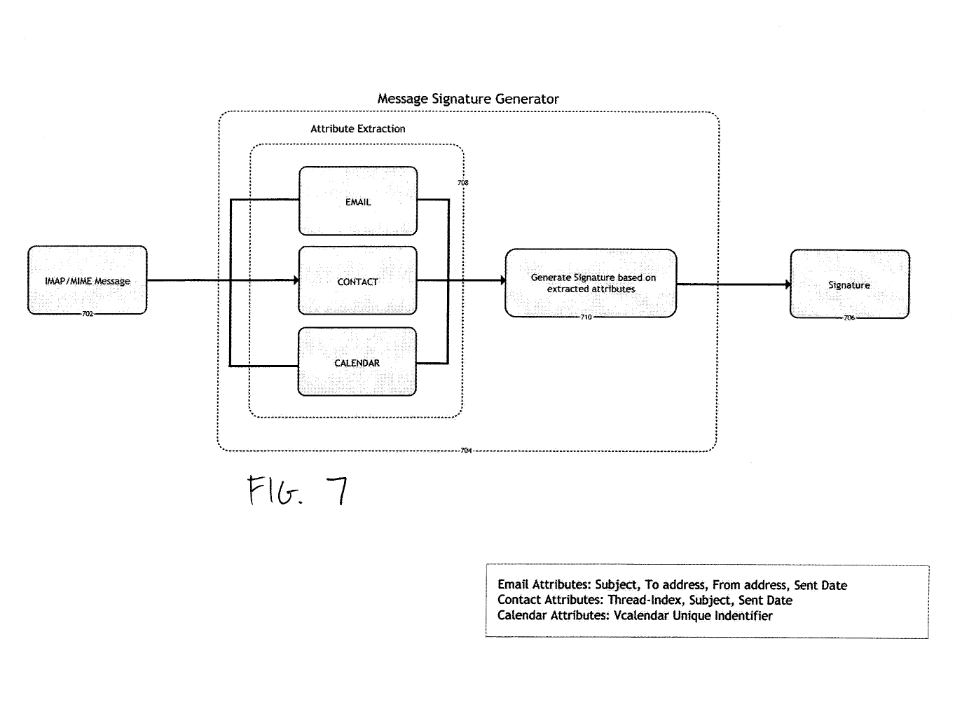

We now discuss more particularly some examples of operational details of the enterprise relay server 404. FIGS. 5 and 5-1 illustrate an optimization of processing a store of messages for determining messaging events. Thus, for example, it is recognized that there may generally be a finite number of connections via which client messaging devices can synchronize with messaging events from enterprise messaging systems (including, for example, if such messaging events have been provided out to an enterprise synchronization service). Synchronization activities (such as synchronizing a large mailbox) may “hog” a connection. In accordance with an example method, synchronization activities (in particular, polling for events) are controlled such that they can be carried out distributed over time. Some activities are deemed to have higher priority and, thus, are carried out with higher priority.

Turning now to FIG. 5, a flowchart illustrates processing for synchronizing an “account” on a client messaging device to the corresponding account on a server. The synchronization is typically accomplished over sequential occurrences of the FIG. 5 processing. (Furthermore, given the asynchronous nature of the environment—i.e., generation of events is not necessarily synchronized with the FIG. 5 processing)—it may be that synchronization processing is never actually completed.

Referring to FIG. 5, processing begins at step 502. At step 504, it is determined if the client messaging device is connected. If the client messaging device is not connected, then a connection is created. In particular, step 508 includes step 510 (determining if more connections are allowed), step 512 (waiting for an available connection, if no more connections are allowed) and step 514 (creating a new connection.) At step 506, messaging events are flushed from the client to the server. For example, IMAP “append” commands are executed to append messages to a destination mailbox on the server.

At step 508, for each folder of interest in the client account mailbox, events bound for the server are flushed. For example, such events may be to alter data associated with messages in a destination mailbox on the server. In addition, the folder is polled according to heuristics, such as the heuristics shown in FIG. 5-1. In particular, there is, on in some sense, a prioritization of the polling such that events that are likely to be higher priority are detected first, and those events that are likely to be a lower priority are detected later and even, perhaps, after the client messaging device has disconnected from, and connected again to, the server. Before discussing the heuristics shown in FIG. 5-1, we first complete our discussion of the overall synchronization processing illustrated in the FIG. 5 flowchart.

At step 510, it is determined if there are pending events on the client side. If so, while connected, at step 512, processing waits for the client to process the pending events. At step 514, it is determined if more connections are needed (i.e., by other client messaging devices). If so, then the connection is closed at step 516. In either case, step 518 indicates that the current synchronization operation is complete.

We now discuss the heuristics shown in FIG. 5-1. FIG. 5-1 shows processing for several sequential occurrences (524 and 526, respectively) of heuristics processing (i.e., two sequential executions of step 508 in FIG. 5).

The highest priority is to check for new messages. This is denoted by reference numeral 552. At reference numeral 552, for occurrence P 524, there is a check for new messages, which is based on which messages were seen during the last occurrence (i.e., Pi-1) of the polling heuristics. At reference numeral 554, there is a check for changes to the “most recent” messages. The “most recent” messages are the most recent of those messages that have been seen during previous occurrences of the heuristics polling. FIG. 5-1 illustrates the specific case where “most recent” messages are those that were first seen during the previous poll (i.e., Pi-1). However, this can be generalized to other criteria, such as a fixed size block of messages. It could also take message characteristics into consideration, such as whether messages are currently marked as unread, or whether they have ever been marked as read.

At step 556, a rolling subset of the “older messages” is polled for changes. The “older messages” are those messages other than the “most recent” messages and the new messages. Only a subset of the older messages is checked each time through step 508 (FIG. 5). The subset that is checked is anchored relative to the start of the anchor for the previous poll of the older messages. In this way, the lower priority checking of older messages does not tie up a connection that may be needed by other client messaging devices.

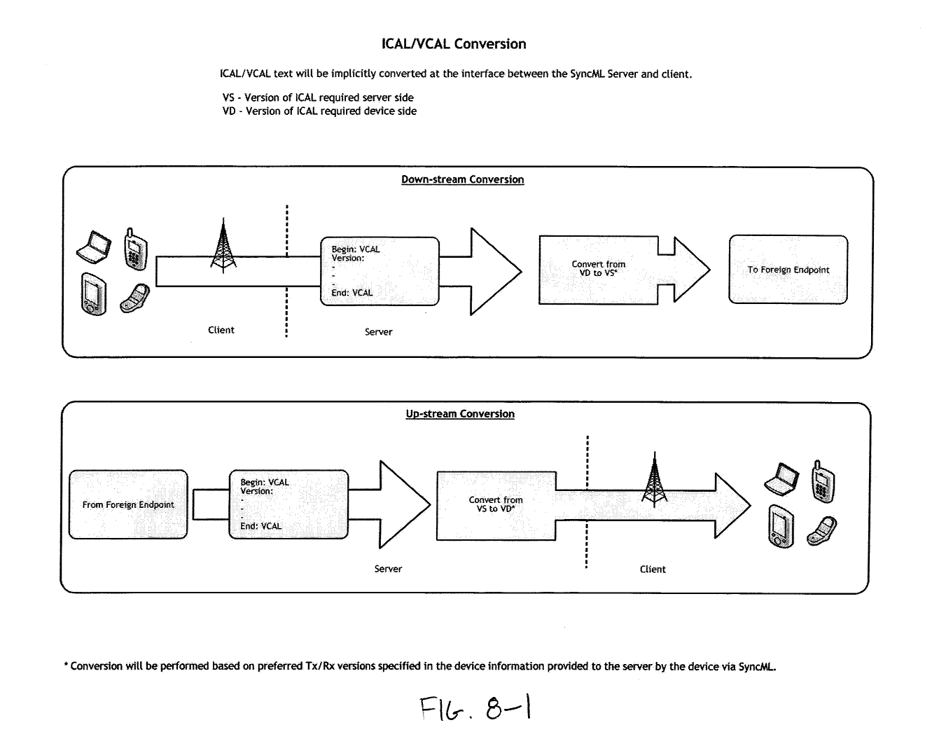

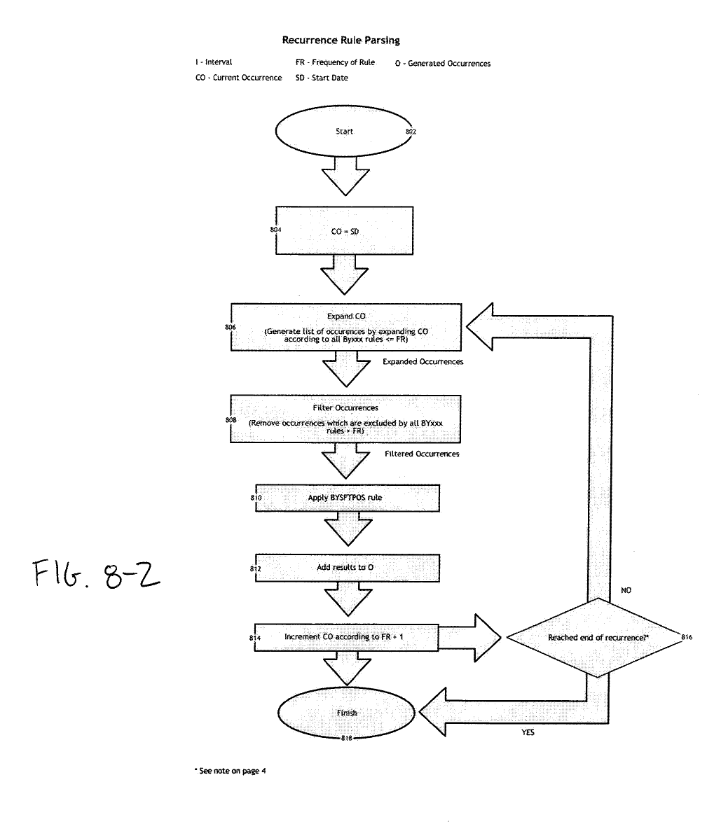

Similar in some aspects to FIG. 3-1, FIG. 6 illustrates an architecture that does not include an enterprise synchronization service. Rather, as will be discussed, according to the FIG. 6 architecture, there is a more direct connection between a messaging client device 608 and servers 604 (e.g., the enterprise messaging systems 301 in FIG. 3) of an enterprise messaging service. That is, for example, disregarding the web servers 606 for the moment, protocol servers 602 are situated between the messaging client device 608 and the servers 604 of the enterprise messaging service for assisting in the communication of messaging events therebetween.

More particularly, the protocol servers 602 function to translate, where appropriate, between a delivery/synchronization protocol of the messaging client device 608 and the delivery/synchronization protocol of the servers 604 of the enterprise messaging service. In one example, the protocol servers 602 operate merely as a pass-through for IMAP-protocol event messages, while acting as a translator for PIMAP-protocol event messages.

Turning now to the web servers 606, these function to allow the messaging client device 608 to communicate (or, at least, appear to communicate) with the servers 604 via HTTP or HTTPS rather than, for example, direct TCP. More particularly, still referring to FIG. 6, arrow 612 indicates establishment of an HTTP (or HTTPS) session between a messaging client device 608 (typically, a wireless messaging client device) and a web server 606a of the collection of web servers 606. The web server 606a performs a UDP multicast 614 to the protocol servers 602. As a result, an IMAP session is established between a protocol server 602a of the enterprise relay service and an IMAP server 604a of the enterprise messaging service 604.

The protocol server 602a provides a TCP unicast of an RMI (remote method invocation) stub for a JavaMail session 618. An RMI object communication 620 results. The RMI object communication 620 is with smart proxies, in that not all method calls result in an RMI invocation. That is, some of the data of the communication may be cached by objects running in the virtual machine of the web server 606a.

Thus, for PIMAP clients, the IMAP4 service 604 appears to be a PIMAP service, since the protocol server 602a handles communication with the PIMAP clients according to the PIMAP protocol.

FIG. 7 illustrates another operational detail of an example of the enterprise relay service 302. In particular, FIG. 7 illustrates generating message signatures for use by the enterprise relay service. As shown in FIG. 7, using an example of an IMAP/MIME format message, a message signature generator 704 processes incoming messages 702 and generates signatures 706 which can then be used to control the message relay (for example, for message synchronization, to determine that a particular message has already been synchronized between an enterprise messaging service and a messaging client device).

An attribute extractor 708 of the message signature generator 704 extracts, as appropriate, attributes of the incoming messages 702. In one example, for an e-mail message, the extracted attributes are subject, to address, from address and sent date. In one example, for a contact message, the extracted attributes are thread-index, subject and sent date. In one example, for a calendar message, the extracted attributes include a unique identifier provided by a calendaring program.

An attribute processor 710 processes the extracted attributes to generate a message signature 706. The generated message signature is maintained (for example, stored into a database) for use in relay processing.

In some examples, the generated message signatures are unique. However, in other examples, the message signatures may not be unique. Thus, in this case, if message signatures are the same, it is still possible that the messages from which the message signatures were generated are unique, and further duplicate checking may be applied. Signatures are useful in the absence of a proper unique id.

In one example of generating message signatures, for email message events, an EmailSyncEvent is constructed and a unique id is assigned to the event. This unique id is retrieved either based on the message signature or provider id and is extracted from a local table. The relay software is then able to suppress the event by verifying (e.g., by directly inspecting the extracted attributes) if this EmailSyncEvent has already been through the system and synchronized to.

In another example, for a calendar message event, the unique id is retrieved from the local table based off the message signature (ical uid). The unique id is then used to retrieve the calendar information stored in the database. The calendar information in the current message is then compared to the stored calendar information for any changes.

In another example, for a contact message event, the corresponding personal contact is located based on an IMAP notification, which includes an RFC822 Message-ID, Thread-Index and Subject. A vCard is built from the located personal contact, and the contact's MAPI PR_ENTRY_ID property is determined. Using the entry ID, any previous reference to the vCard in the database tables is located and the previously experienced vCard is found. If the two vCards are equivalent, then there is a duplicate and the new one can be ignored; otherwise the two tables are updated with the new vCard. In this example, the message signature is not generated, since the available message header items from which to generate a message signature do not vary when the contact is modified.

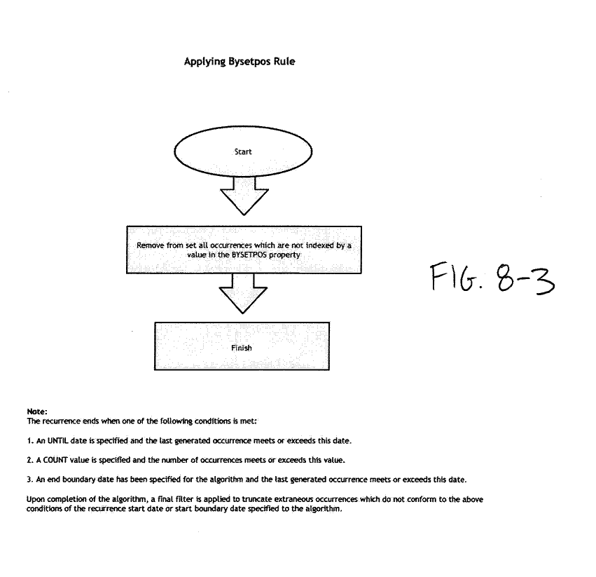

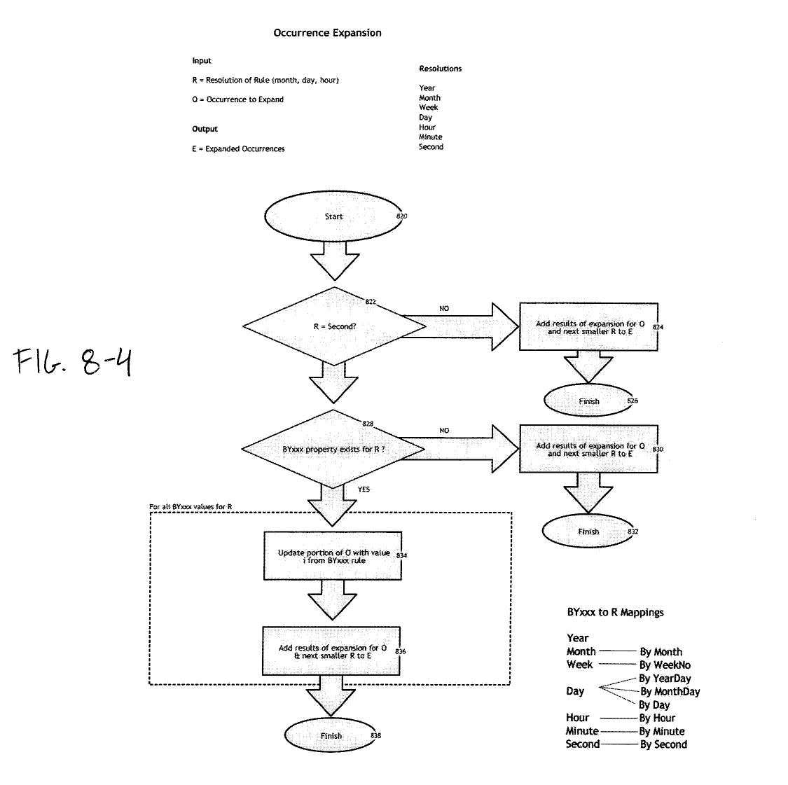

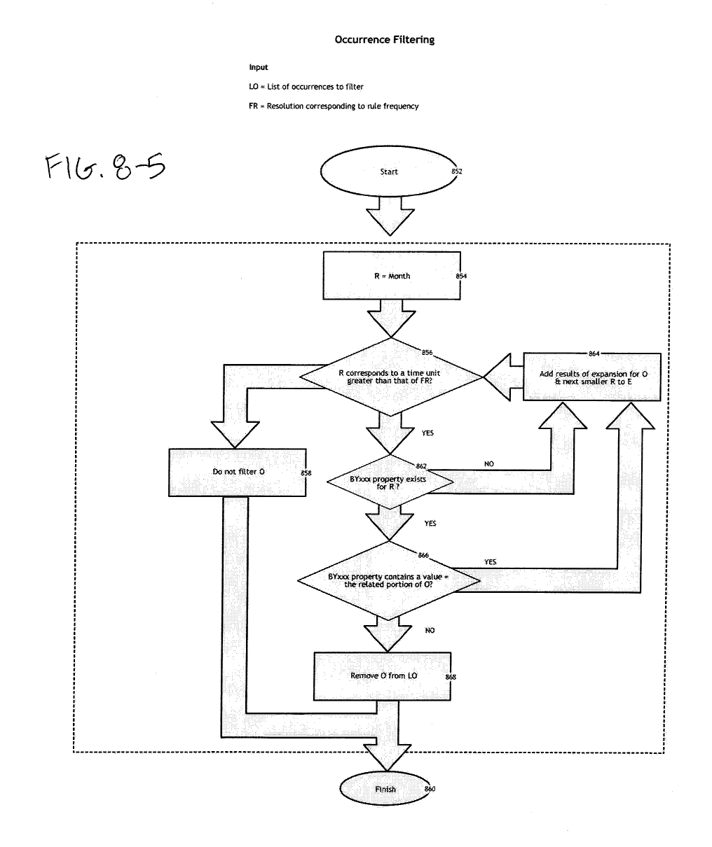

FIGS. 8-1 to 8-5 illustrate particular details to synchronize calendar entries. FIG. 8-1 illustrates an example of synchronizing calendar entries that that have different formats, e.g., different formats for the ical or real data types.

FIG. 8-1 shows, generally, that the conversion is performed between the messaging client and a foreign endpoint and vice versa. For example, the conversion may be performed on a synchronization server according to Tx/Rx versions specified in messaging client device information provided to the server by the messaging client device via SyncML messages.

FIGS. 8-2 to 8-5 illustrate recurrence rule normalizing usable in the process of synchronizing calendar entries, and the calendar entries may have the same format on both sides of the synchronization. FIGS. 8-2 to 8-5 illustrate a particular method of parsing (including expanding and filtering) recurrence rules of the calendar entries to and from a normalized format used for synchronization.

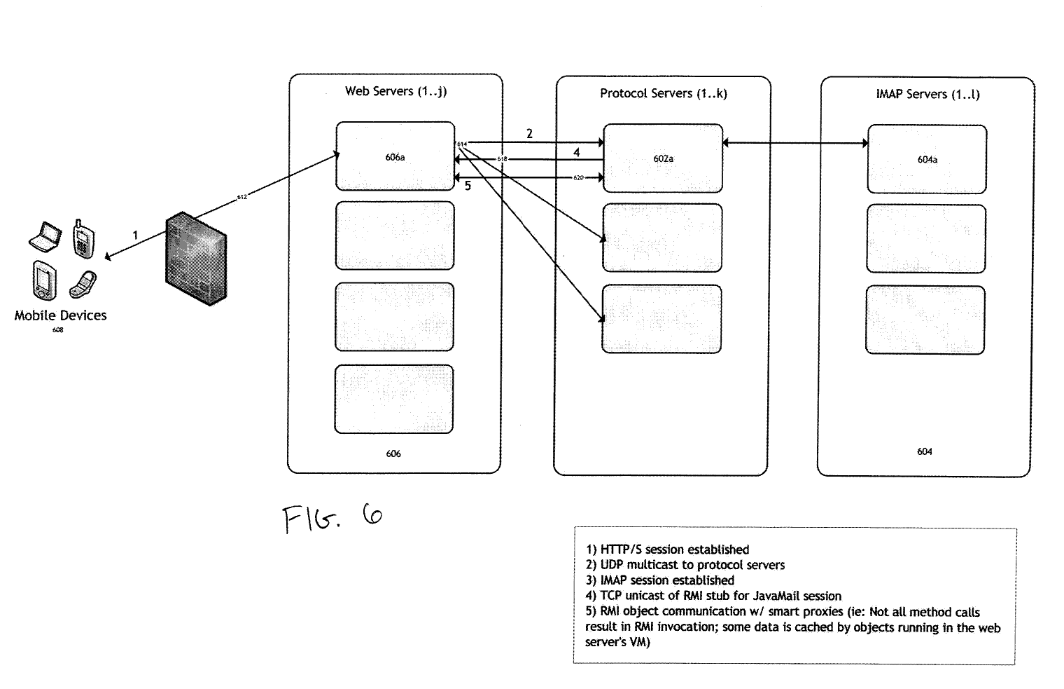

In particular, FIG. 8-2 is a flowchart illustrating an example of a process at a relatively high level, while FIGS. 8-3 to 8-5 illustrate constituent parts of the FIG. 8-2 process. The FIG. 8-2 process begins at step 802. At step 804, the “current occurrence” is set to the “start date” of the period for the recurrence rule. At step 806, the current occurrence is expanded according to an expansion characterization of the recurrence rule. Thus, for example, a recurrence rule that is “by X” (where “X” is a particular recurrence resolution, such as “second,” “minute,” etc.) is expanded into constituent occurrences. More detail of an example of step 806 is illustrated in FIG. 8-4.

At step 808, the expanded occurrences are filtered according to filtering rules. The filtering rules apply “exceptions” to the expansion of step 804. For example, the expansion rule may be “every day,” whereas the exception may be “except Saturday and Sunday.” At step 806, the entry would be expanded into all days whereas, at step 808, the list of “all days” would be filtered to remove Saturdays and Sundays. More detail of an example of step 808 is illustrated in FIG. 8-5.

Then, at step 810, the filtered occurrences are then subject to a “set position” rule. In particular, the “set position” rule removes from the expanded set of occurrences all occurrences that are not within a particular time period. More detail of an example of step 810 is illustrated in FIG. 8-3.

At step 812, the output of step 810 is added to the generated occurrences and, at step 814, processing increments to the next current occurrence (if any), according to the frequency of the rule being parsed. If the end of the recurrence has not been reached, then processing returns to step 806 for the next current occurrence. Recurrence rule parsing processing ends at step 818.

In one example, the recurrence ends when a particular condition is met. For example, the conditions that may be met include:

An UNTIL date is specified in the recurrence and the last generated occurrence meets or exceeds this date.

A COUNT value is specified in the recurrence and the number of occurrences meets or exceeds this date.

An END BOUNDARY date has been specified for the algorithm and the last generated occurrence meets or exceeds this date.

We now discuss more details of the FIG. 8-2 recurrence rule parsing with reference to FIGS. 8-4, 8-5 and 8-3. As mentioned above, FIG. 8-4 illustrates more detail of an example of step 806 (occurrence expansion) of the FIG. 8-2 flowchart. Before describing FIG. 8-4, it is noted that the processing described there is, in some instances, invoked recursively.

Turning now to FIG. 8-4, the processing begins at step 820. At step 822, it is determined if the resolution (“R”) of the recurrence rule currently being parsed is a second. If so, then the occurrence is added to the set of expanded occurrences at step 824, and processing finishes at step 826. In this example, a second is the smallest resolution that is handled. Furthermore, in this example, there is no “rule” that is applicable to resolutions of a second.

Otherwise, at step 828, it is determined if there is a recurrence mapping rule for the resolution “R.” In FIG. 8-4, the recurrence mapping rules are indicated as “Byxxx” rules. If it is determined that there is not a recurrence mapping rule for the resolution “R,” then at step 830, the results of the expansion for the occurrence, as well as the results of the expansion for the next smaller “R,” are added to the set of expanded occurrences. At step 830, the results of the expansion for the occurrence and the next smaller “R” are added to the set of expanded occurrences. For example, determining the results for the next smaller “R” may involve recursively invoking the FIG. 8-4 processing, with the next smaller “R.” This is one example of a recursive invocation of the FIG. 8-4 processing, mentioned above. At step 832, processing is finished.

The box surrounding steps 834 and steps 836 indicates that, for example, the processing of steps 834 and 836 may occur for in a loop, with each pass through the loop being for a different Byxxx value (e.g., the values may be in a list, such as a comma-delimited list). If it is determined that there is a recurrence mapping rule for the resolution “R” (step 828), then at step 834, a portion of the occurrence to be expanded is updated with a value from the recurrence mapping rule for the recurrence resolution “R.” At step 836, similar to step 830, the results of the expansion for the occurrence and the next smaller “R” are added to the set of expanded occurrences. At step 836, processing is finished. In step 836, similar to step 830, for example, determining the results for the next smaller “R” may involve recursively invoking the FIG. 8-4 processing, with the next smaller “R.” This is another example of a recursive invocation of the FIG. 8-4 processing, mentioned above. At step 838, processing is finished.

As discussed above, FIG. 8-5 illustrates an example of the step 808 (FIG. 8-2) processing in greater detail. In general, the FIG. 8-5 processing operates to remove particular occurrences as indicated by properties existing for each resolution. As an example, a recurrence rule may indicate “every day,” where BYMONTH=JANUARY. Thus, all occurrences at resolution of “month” but not in January should be removed. It is noted that the processing in FIG. 8-5 is carried out for each occurrence in the list of occurrences resulting from the FIG. 8-4 occurrence expansion processing.

Turning now to FIG. 8-5, processing begins at step 852. The resolution (R) of occurrences to potentially filter is initially set to MONTH. That is, for the FIG. 8-5 example, MONTH is the highest resolution processed. At step 856, it is determined if the current resolution (i.e., initially (R)) is greater than the frequency of the rule. If so, then no occurrences are filtered (858) and processing steps at step 860.

Otherwise, it is determined at step 862 if a BYXXX property exists for the current resolution. If there is no such property, then it is implicit that there are no occurrences to filter for the resolution (R) and processing continues at step 864. At step 864, the resolution (R) is set to the next smallest resolution and processing returns to step 856.

If, at step 862, if there is a BYXXX property for the current resolution, the processing continues to step 866 and the processing for the following steps is repeated for each occurrence in a list of occurrences. At otherwise, processing continues to steps 864 and 856. At step 866, if the portion of the occurrence does not match the property for the current resolution, then the occurrences is removed from the list of occurrences (step 868) and processing continues to step 860.

After the FIG. 8-5 processing is carried out for each occurrence in the expanded list of occurrences, then, as shown in FIG. 8-2, processing continues at the “set position” processing of step 810. A detailed example of the step 810 processing is shown in FIG. 8-3.

We now discuss, with reference to FIG. 8-3, application of the “set position” rule (“BYSETPOS” rule shown at step 810 in FIG. 8-2). Basically, the FIG. 8-3 processing is used to filter out occurrences that do not meet particular conditions. The BYSETPOS rule is applied after all other rules and provides indices into the previously generated occurrences (per iteration) to act as a further filter.

For example, the recurrence rule may specify an UNTIL date, and there may be occurrences that meet or exceed this date. The occurrences that meet or exceed the UNTIL date would be filtered out. As another example, a COUNT value may be specified and the number of occurrences meets or exceeds the COUNT value. Thus, occurrences may be filtered out to meet the COUNT value condition. As yet another example, an end boundary data may be specified and the last generated occurrences meets or exceeds this date.

In a particular implementation, the BYSETPOS provides indices into the previously generated occurrences (per iteration) to act as a filter (e.g. BYSETPOS=−1,1 means take all occurrences generated by the rest of the rule and filter all but the first and last timewise). The BYXXX rules refer to all other rule parts that start with “BY” (e.g. BYMONTH, BYDAY, BYHOUR, etc.) These all act as either filters or expanders depending on the frequency of the rule (e.g. in “RRULE:FREQ=WEEKLY;BYMONTH=1,2;BYDAY=MO,WE,FR”, the BYDAY rule will generate extra occurrences (to be filtered out) per each iteration of the rule (i.e. each week), while the BYMONTH rule will filter all occurrences in an iteration if the month is not January or February).

Another detail of the operation of the enterprise relay service, and which is more generally applicable, is a garbage collection technique. More specifically, using the technique, garbage collection for an object occurs in the same thread as the thread that created the object. This avoids the requirement to wait until the garbage collector thread to reclaim these resources.

FIG. 4 is a flowchart illustrating portions of an example thread 400 including the garbage collection technique. At step 402, an object is created. At step 404, it is determined if the thread local storage has a reference queue. If it is determined that the thread local storage does not have a reference queue, then, at step 406, a reference queue is created and associated with thread local storage.

At step 408, the object created at step 402 is wrapped in a phantom reference associated with the thread's reference queue. Step 410 indicates waiting for the thread to finish some work. At step 412, the reference queue is polled for the enqueued phantom reference. At step 414, it is determined if the polled reference queue is empty. If the reference queue is empty, then execution continues by returning to step 410.

Otherwise, if the reference queue is not empty, execution continues at step 416, where cleanup is performed and the phantom reference is cleared. At step 418, the object created at step 402 is destroyed.

What is claimed is:

1. A system configured to interface a plurality of electronic messaging systems to a plurality of client devices connectable wirelessly to the system, the system comprising:
a client protocol engine configured to accomplish a client-side connection to each of the plurality of wireless client devices; and
a server protocol engine configured to accomplish a messaging system side connection to each of the plurality of electronic messaging systems,
wherein the client protocol engine and the server protocol engine are configured to cooperatively couple each of a plurality of client-side connections, each between a particular one of the wireless client devices and the client protocol engine, to a particular server-side connection, each between a particular one of the electronic messaging systems and the server protocol engine,
whereby the system accomplishes a many-to-one-to-many connection between wireless client devices and electronic messaging systems.

2. The system of claim 1, wherein:
the server protocol engine operates to transform messaging events from the wireless client devices into a specific format appropriate for the particular electronic messaging system to which the wireless client device is connected through the client protocol engine and the server protocol engine, and transforming responses thereto from the particular electronic messaging system to a format appropriate to the wireless client device.

3. A method of operating a relay engine to interface a plurality of enterprise messaging systems to a plurality of client devices connectable wirelessly to the system, the electronic messaging systems providing messaging system events, without persistently storing any information pertaining to the events in the relay engine the method comprising:
processing messaging system events to determine whether to relay the event and,
when it is determined to relay an event, retrieving information from the enterprise messaging system and relaying the information directly to the client device without storing the information persistently.

4. The method of claim 3, wherein:
the information to be relayed can include a payload of an e-mail message, calendar event, contact information.

5. In a relay engine configured to relay electronic messaging events among at least one electronic messaging system and at least one client device, a method comprising:
processing electronic messaging events among the at least one electronic messaging system and at least one client device to, for each electronic messaging event, generate an event signature;
maintaining the event signatures;
determining, for a particular electronic messaging event, whether a corresponding electronic messaging event has occurred, wherein the determining step includes at least processing the maintained event signatures; and
based on a determination that a corresponding electronic messaging event has not occurred, performing a relay action among the at least one electronic messaging system and the at least one client device based on the particular electronic messaging event.

6. The method of claim 5, wherein:
the step of determining whether a corresponding electronic messaging event has occurred includes:
making a preliminary determination based on at least processing the maintained event signatures; and
based on a preliminary determination that a corresponding messaging event has occurred, accessing information about the messaging event preliminarily determined to have occurred, in addition to the maintained event signature for the event, to make a decisive determination of whether the messaging event has occurred.

7. The method of claim 5, wherein:
when it is determined that the corresponding messaging event has not occurred, performing the relay action includes obtaining the particular electronic messaging event, to which the event signature corresponds, and performing the relay action among the at least one electronic messaging system and the at least one client device based on the obtained particular electronic messaging event.

8. A system including at least one protocol server to interface to a messaging service, wherein the at least one protocol server is configured to pass messaging commands among a client device and the messaging service, wherein:
if the commands are formatted according to a first particular protocol, the commands are passed through the at least one protocol server substantially without changing the format; and
if the commands are formatted according to a second particular protocol, the commands are passed through the at least one protocol server with the messages formatted according to the first particular protocol as the messages are passed through the at least one protocol server
whereby the protocol server functions to selectively translate between a delivery/relay protocol of the client device and the delivery/relay protocol of the messaging service.

9. The system of claim 8, further comprising:
at least one web server, wherein the at least one web server is configured to communicate with the client device according to a third protocol.

10. A method of synchronizing an account using a connection, comprising:
polling the account for events in a plurality of sequentially executed passes, according to polling heuristics, wherein:
during each sequentially executed pass, the heuristics characterize a portion of the account which to poll for events during that pass.

11. The method of claim 10, wherein:
the portion of the account which to poll during a particular pass is determined relative to a portion of the account that was polled during a previous pass.

12. The method of claim 11, wherein:
the portion of the account which to poll further includes messages that are new since a previous executed pass.

13. The method of claim 11, wherein:
the portion of the account which to poll further includes messages that are most recent messages.

14. The method of claim 11, further comprising:
during the particular pass, relinquishing the connection if the connection is otherwise needed.

15. A method of relaying calendar entries from a first format to a second format, wherein a messaging client operates upon calendar entries according to one of the first format and the second format and a foreign endpoint operates according to the other of the first format and the second format, the method comprising:
for each of at least some of the occurrences represented by calendar entries in the first format,
expanding that occurrence according to an expansion characterization for a recurrence rule associated with that occurrence;
filtering the result of the expanding step with respect to applicable exceptions to the expanding step;
applying a set position rule to remove occurrences from the filtered result of the expanding step that are not within a time period characterized by the set position rule.

16. A method of garbage collection for an object executing on a computer, comprising:
creating the object in a particular thread of execution;
executing the object in the particular thread; and
within the particular thread, performing garbage collection related to executing the object.

17. The method of claim 16, wherein:
associating the object with a phantom reference associated a reference queue for the object;
performing garbage collection related to executing the object includes checking the reference queue for the phantom reference and, if the reference queue is empty, performing the garbage collection related to executing the object.
